(19) United States
(12) Patent Application Publication
(10) Pub. No.: US 2026/0171560 A1
(43) Pub. Date: Jun. 18, 2026

(54) COATED BATTERY THERMAL ISOLATION STRUCTURE AND METHOD

(71) Applicant: ASPEN AEROGELS, INC., Northborough, MA (US)

(72) Inventors: Lixin Wang, Northborough, MA (US); Christopher Stow, Northborough, MA (US)

(21) Appl. No.: 19/126,168

(22) PCT Filed: Oct. 26, 2023
(86) PCT No.: PCT/US2023/036008

§ 371 Date: Apr. 30, 2025

Related U.S. Application Data
(60) Provisional application No. 63/426,311, filed on Nov. 17, 2022.

(51) Int. Cl. H01M 50/124; H01M 10/613; H01M 10/625; H01M 10/658; H01M 50/211

(52) U.S. Cl. CPC H01M 50/1245; H01M 10/613; H01M 10/625; H01M 10/658; H01M 50/211

(57) ABSTRACT

A battery module, and associated methods are disclosed. In one example, a battery module includes thermal regulating member with a structural support plate and an aerogel layer. An aerogel density gradient is shown at an interface between the structural support plate and the aerogel layer.

### CLAIM OF PRIORITY

This patent application claims the benefit of priority to U.S. Provisional Patent Application Ser. No. 63/426,311, entitled “COATED BATTERY THERMAL ISOLATION STRUCTURE AND METHOD,” filed on Nov. 17, 2022, which is hereby incorporated by reference herein in its entirety.

### TECHNICAL FIELD

The present disclosure relates generally to materials and systems and methods for preventing or mitigating thermal events, such as thermal runaway issues, in energy storage systems. In particular, the present disclosure provides thermal barrier materials. The present disclosure further relates to a battery module or pack with one or more battery cells that includes the thermal barrier materials, as well as systems including those battery modules or packs. Examples described generally may include aerogel materials.

### BACKGROUND

Lithium-ion batteries (LIBs) are widely used in powering portable electronic devices such as cell phones, tablets, laptops, power tools and other high-current devices such as electric vehicles because of their high working voltage, low memory effects, and high energy density compared to traditional batteries. However, safety is a concern as LIBs are susceptible to catastrophic failure under “abuse conditions” such as when a rechargeable battery is overcharged (being charged beyond the designed voltage), over-discharged, operated at or exposed to high temperature and high pressure.

To prevent cascading thermal runaway events from occurring, there is a need for effective insulation and heat dissipation strategies to address these and other technical challenges of LIBs.

### BRIEF DESCRIPTION OF THE DRAWINGS

FIG. 1 shows a battery system in accordance with some aspects.

FIG. 2 shows a battery module in accordance with some aspects.

FIG. 3 shows another battery module in accordance with some aspects.

FIG. 4 shows another battery module in accordance with some aspects.

FIG. 5A shows a thermal regulating member in accordance with some aspects.

FIG. 5B shows another thermal regulating member in accordance with some aspects.

FIG. 5C shows another thermal regulating member in accordance with some aspects.

FIG. 5D shows another thermal regulating member in accordance with some aspects.

FIG. 5E another thermal regulating member in accordance with some aspects.

FIG. 5F another thermal regulating member in accordance with some aspects.

FIG. 6 shows a flow chart of a method in accordance with some aspects.

FIG. 7 shows an electronic device in accordance with some aspects.

FIG. 8 shows an electric vehicle in accordance with some aspects.

### DESCRIPTION OF EMBODIMENTS

The following description and the drawings sufficiently illustrate specific aspects to enable those skilled in the art to practice them. Other aspects may incorporate structural, logical, electrical, process, and other changes. Portions and features of some aspects may be included in, or substituted for, those of other aspects. Aspects set forth in the claims encompass all available equivalents of those claims.

The present disclosure is directed to a thermal regulating member between a stack of battery cells (e.g., lithium-ion cells) in a battery module or a battery pack. The thermal regulating member is also referred to as thermal barrier or thermal regulating barrier hereafter. The thermal regulating member includes an insulating material layer and a structural support layer.

The insulating material layer reduces or prevents heat transfer between battery cells. In some aspects, the insulating material layer includes aerogel. The insulating material layer is therefore also referred to as an aerogel layer hereafter.

The structural support layer mechanically supports the insulating material layer. The structural support layer may include a thermal conductive layer in some aspect. The thermal conductive layer helps to dissipate undesired heat away from the battery cells.

### I. Insulation Materials

Insulation materials, as described in examples below, can be used as a single heat resistant layer, or in combination with other layers that provide additional function to a multilayer configuration, such as mechanical strength, compressibility, heat dissipation/conduction, etc. Insulation layers described herein are responsible for reliably containing and controlling heat flow from heat-generating parts in small spaces and to provide safety and prevention of fire propagation for such products in the fields of electronic, industrial and automotive technologies. Insulation materials are also referred to as insulation material layer, insulation layer, or aerogel layer.

In many aspects of the present disclosure, the insulation layer functions as a flame/fire deflector layer either by itself or in combination with other materials that enhance performance of containing and controlling heat flow. For example, the insulation layer may itself be resistant to flame and/or hot gases and further include entrained particulate materials that modify or enhance heat containment and control.

One example of a highly effective insulation layer includes an aerogel. Aerogels describe a class of material based upon their structure, namely low density, open cell structures, large surface areas (often 900 m²/g or higher) and subnanometer scale pore sizes. The pores may be filled with gases such as air. Aerogels can be distinguished from other porous materials by their physical and structural properties. Although an aerogel material is an exemplary insulation material, the invention is not so limited. Other thermal insulation material layers may also be used in examples of the present disclosure.

Selected examples of aerogel formation and properties are described. In several examples, a precursor material is gelled to form a network of pores that are filled with solvent. The solvent is then extracted, leaving behind a porous matrix. A variety of different aerogel compositions are known, and they may be inorganic, organic and inorganic/organic hybrid. Inorganic aerogels are generally based upon metal alkoxides and include materials such as silica, zirconia, alumina, and other oxides. Organic aerogels include, but are not limited to, urethane aerogels, resorcinol formaldehyde aerogels, and polyimide aerogels.

Inorganic aerogels may be formed from metal oxide or metal alkoxide materials. The metal oxide or metal alkoxide materials may be based on oxides or alkoxides of any metal that can form oxides. Such metals include, but are not limited to silicon, aluminum, titanium, zirconium, hafnium, yttrium, vanadium, cerium, and the like. Inorganic silica aerogels are traditionally made via the hydrolysis and condensation of silica-based alkoxides (such as tetraethoxylsilane), or via gelation of silicic acid or water glass. Other relevant inorganic precursor materials for silica based aerogel synthesis include, but are not limited to metal silicates such as sodium silicate or potassium silicate, alkoxysilanes, partially hydrolyzed alkoxysilanes, tetraethoxylsilane (TEOS), partially hydrolyzed TEOS, condensed polymers of TEOS, tetramethoxylsilane (TMOS), partially hydrolyzed TMOS, condensed polymers of TMOS, tetra-n-propoxysilane, partially hydrolyzed and/or condensed polymers of tetra-n-propoxysilane, polyethylsilicates, partially hydrolyzed polyethysilicates, monomeric alkylalkoxy silanes, bis-trialkoxy alkyl or aryl silanes, polyhedral silsesquioxanes, or combinations thereof.

In certain aspects of the present disclosure, pre-hydrolyzed TEOS, such as Silbond H-5 (SBH5, Silbond Corp), which is hydrolyzed with a water/silica ratio of about 1.9-2, may be used as commercially available or may be further hydrolyzed prior to incorporation into the gelling process. Partially hydrolyzed TEOS or TMOS, such as polyethysilicate (Silbond 40) or polymethylsilicate may also be used as commercially available or may be further hydrolyzed prior to incorporation into the gelling process.

Inorganic aerogels can also include gel precursors comprising at least one hydrophobic group, such as alkyl metal alkoxides, cycloalkyl metal alkoxides, and aryl metal alkoxides, which can impart or improve certain properties in the gel such as stability and hydrophobicity. Inorganic silica aerogels can specifically include hydrophobic precursors such as alkylsilanes or arylsilanes. Hydrophobic gel precursors may be used as primary precursor materials to form the framework of a gel material. However, hydrophobic gel precursors are more commonly used as co-precursors in combination with simple metal alkoxides in the formation of amalgam aerogels. Hydrophobic inorganic precursor materials for silica based aerogel synthesis include, but are not limited to trimethyl methoxysilane (TMS), dimethyl dimethoxysilane (DMS), methyl trimethoxysilane (MTMS), trimethyl ethoxysilane, dimethyl diethoxysilane (DMDS), methyl triethoxysilane (MTES), ethyl triethoxysilane (ETES), diethyl diethoxysilane, dimethyl diethoxysilane (DMDES), ethyl triethoxysilane, propyl trimethoxysilane, propyl triethoxysilane, phenyl trimethoxysilane, phenyl triethoxysilane (PhTES), hexamethyldisilazane and hexaethyldisilazane, and the like. Any derivatives of any of the above precursors may be used and specifically certain polymeric of other chemical groups may be added or cross-linked to one or more of the above precursors.

Organic aerogels are generally formed from carbon-based polymeric precursors. Such polymeric materials include, but are not limited to resorcinol formaldehydes (RF), polyimide, polyacrylate, polymethyl methacrylate, acrylate oligomers, polyoxyalkylene, polyurethane, polyphenol, polybutadiane, trialkoxysilyl-terminated polydimethylsiloxane, polystyrene, polyacrylonitrile, polyfurfural, melamine-formaldehyde, cresol formaldehyde, phenol-furfural, polyether, polyol, polyisocyanate, polyhydroxybenze, polyvinyl alcohol dialdehyde, polycyanurates, polyacrylamides, various epoxies, agar, agarose, chitosan, and combinations thereof. As one example, organic RF aerogels are typically made from the sol-gel polymerization of resorcinol or melamine with formaldehyde under alkaline conditions.

Organic/inorganic hybrid aerogels are mainly comprised of (organically modified silica (“ormosil”) aerogels. These ormosil materials include organic components that are covalently bonded to a silica network. Ormosils are typically formed through the hydrolysis and condensation of organically modified silanes, R—Si(OX)₃, with traditional alkoxide precursors, Y(OX)₄. In these formulas, X may represent, for example, CH₃, C₂H₅, C₃H₇, C₄H₉; Y may represent, for example, Si, Ti, Zr, or Al; and R may be any organic fragment such as methyl, ethyl, propyl, butyl, isopropyl, methacrylate, acrylate, vinyl, epoxide, and the like. The organic components in ormosil aerogel may also be dispersed throughout or chemically bonded to the silica network.

Aerogels can be formed from flexible gel precursors. Various flexible layers, including flexible fiber-reinforced aerogels, can be readily combined and shaped to give pre-forms that when mechanically compressed along one or more axes, give compressively strong bodies along any of those axes.

One method of aerogel formation includes batch casting. Batch casting includes catalyzing one entire volume of sol to induce gelation simultaneously throughout that volume. Gel-forming techniques include adjusting the pH and/or temperature of a dilute metal oxide sol to a point where gelation occurs. Suitable materials for forming inorganic aerogels include oxides of most of the metals that can form oxides, such as silicon, aluminum, titanium, zirconium, hafnium, yttrium, vanadium, and the like. Particularly preferred are gels formed primarily from alcohol solutions of hydrolyzed silicate esters due to their ready availability and low cost (alcogel). Organic aerogels can also be made from melamine formaldehydes, resorcinol formaldehydes, and the like.

In one example, aerogel materials may be monolithic, or continuous throughout a structure or layer. In other examples, an aerogel material may include a composite aerogel material with aerogel particles that are mixed with a binder. Other additives may be included in a composite aerogel material, including, but not limited to, surfactants that aid in dispersion of aerogel particles within a binder. A composite aerogel slurry may be applied to a supporting plate such as a mesh, felt, web, foam, blanket, net, batting, etc. and then dried to form a composite aerogel structure.

As noted above, an aerogel may be organic, inorganic, or a mixture thereof. In some examples, the aerogel includes a silica-based aerogel. One or more layers in a thermal barrier may include a reinforcement material. The reinforcing material may be any material that provides resilience, conformability, or structural stability to the aerogel material. Examples of reinforcing materials include, but are not limited to, open-cell macroporous framework reinforcement materials, closed-cell macroporous framework reinforcement materials, open-cell membranes, honeycomb reinforcement materials, polymeric reinforcement materials, and fiber reinforcement materials such as discrete fibers, woven materials, non-woven materials, needled non-wovens, batts, battings, webs, mats, felts, or combinations thereof.

The reinforcement material can be selected from organic polymer-based fibers, inorganic fibers, carbon-based fibers or a combination thereof. The inorganic fibers are selected from glass fibers, rock fibers, metal fibers, boron fibers, ceramic fibers, basalt fibers, or combination thereof. In some examples, the reinforcement material can include a reinforcement including a plurality of layers of material.

Fiber reinforcement materials can comprise a range of materials, including, but not limited to: Polyesters, polyolefin terephthalates, poly(ethylene) naphthalate, polycarbonates (examples Rayon, Nylon), cotton, (e.g. lycra manufactured by DuPont), carbon (e.g. graphite), polyacrylonitriles (PAN), oxidized PAN, pre-oxidized PAN, uncarbonized heat treated PANs (such as those manufactured by SGL carbon), glass or fiberglass based material (like S-glass, 901 glass, 902 glass, 475 glass, E-glass) silica based fibers like quartz, (e.g. Quartzel manufactured by Saint-Gobain), Q-felt (manufactured by Johns Manville), Saffil (manufactured by Saffil), Durablanket (manufactured by Unifrax) and other silica fibers, Duraback (manufactured by Carborundum), Polyaramid fibers like Kevlar, Nomex, Sontera (all manufactured by DuPont), Conex (manufactured by Taijin), polyolefins like Tyvek (manufactured by DuPont), Dyneema (manufactured by DSM), Spectra (manufactured by Honeywell), other polypropylene fibers like Typar, Xavan (both manufactured by DuPont), fluoropolymers like PTFE with trade names as Teflon (manufactured by DuPont), Goretex (manufactured by W.L. GORE), Silicon carbide fibers like Nicalon (manufactured by COI Ceramics), ceramic fibers like Nextel (manufactured by 3M), Acrylic polymers, fibers of wool, silk, hemp, leather, suede, PBO-Zylon fibers (manufactured by Tyobo), Liquid crystal material like Vectan (manufactured by Hoechst), Cambrelle fiber (manufactured by DuPont), Polyurethanes, polyamaides, Wood fibers, Boron, Aluminum, Iron, Stainless Steel fibers and other thermoplastics like PEEK, PES, PEI, PEK, PPS.

The glass or fiberglass-based fiber reinforcement materials may be manufactured using one or more techniques. In certain embodiments, it is desirable to make them using a carding and cross-lapping or air-laid process. In exemplary embodiments, carded and cross-lapped glass or fiberglass-based fiber reinforcement materials provide certain advantages over air-laid materials. For example, carded and cross-lapped glass or fiberglass-based fiber reinforcement materials can provide a consistent material thickness for a given basis weight of reinforcement material. In certain additional embodiments, it is desirable to further needle the fiber reinforcement materials with a need to interlace the fibers in z-direction for enhanced mechanical and other properties in the final aerogel composition.

### II. The Structural Support Layer

The thermal regulating element further includes a structural support layer. The structural support layer may be in the forms of a plate, slab, mesh, felt, web, foam, blanket, paper, net, batting, other forms, or combinations thereof. In selected aspects, the structural support layer may include pores, fibers, or other surface structure that results in a diffusion layer at an application interface. The structural support layer comprises materials selected from polymers, mica, ceramic, resin, rubber, composite materials, other suitable materials, or combinations thereof. In some aspect, the structural support layer includes an aerogel with reinforcement, such as a fiber reinforced aerogel blanket.

The structural support layer may be a conductive layer in some aspects. The thermally conductive layers in combination with thermal insulating layers are effective at channeling unwanted heat to a desired external location, such as external heat dissipating fins, a heat dissipating housing, or other external structure to dissipate unwanted heat to outside ambient air. The thermal conductive layer is also referred to as the thermal conductor plate hereafter. In one aspect, a thermally conductive layer or layers helps to dissipate heat away from a localized heat load within a battery module or pack. Examples of high thermal conductivity materials include carbon fiber, graphite, silicon carbide, metals including but not limited to copper, stainless steel, aluminum, and the like, as well as combinations thereof. In one aspect, a thermally conductive layer may include a cooling channel with coolant flow therein.

To aid in the distribution and removal of heat by, in at least one aspect the thermally conductive layer is coupled to a heat sink. It will be appreciated that there are a variety of heat sink types and configurations, as well as different techniques for coupling the heat sink to the thermally conductive layer, and that the present disclosure is not limited to the use of any one type of heat sink/coupling technique. For example, at least one thermally conductive layer of the multilayer materials disclosed herein can be in thermal communication with an element of a cooling system of a battery module or pack, such as a cooling plate or cooling channel of the cooling system. For another example, at least one thermally conductive layer of the multilayer materials disclosed herein can be in thermal communication with other elements of the battery pack, battery module, or battery system that can function as a heat sink, such as the walls of the pack, module or system, or with other ones of the multilayer materials disposed between battery cells. Thermal communication between the thermally conductive layer of the multilayer materials and heat sink elements within the battery system can allow for removal of excess heat from the cell or cells adjacent to the multilayer material to the heat sink, thereby reducing the effect, severity, or propagation of a thermal event that may generate excess heat.

### III. Aspects of Battery Systems Including the Thermal Regulating Member

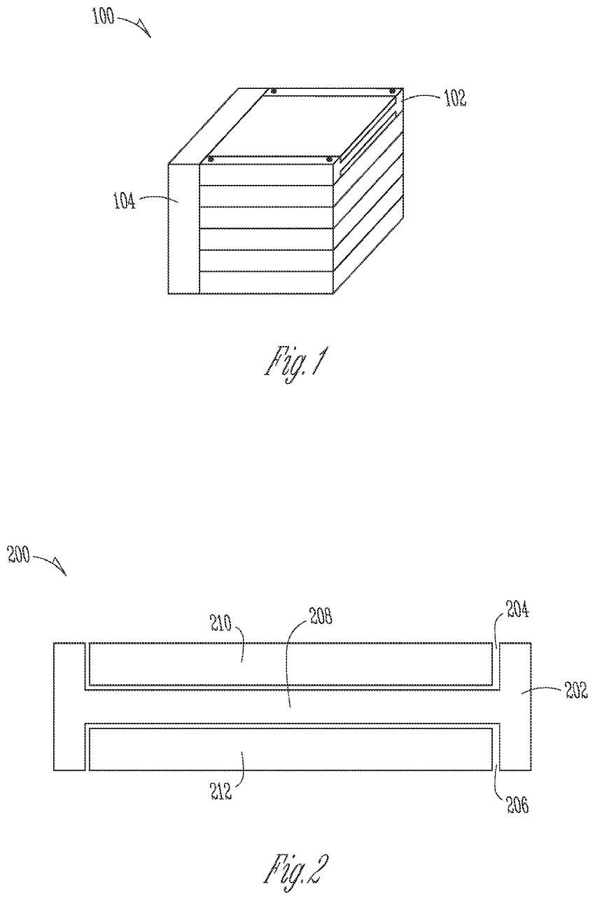

FIG. 1 shows one example of a battery system 100. The system 100 includes one or more battery modules 102. In the example of FIG. 1, each module includes a carrier frame and two batteries. A heat sink 104 is shown located on a side of the system 100, and in thermal communication with the battery modules 102. FIG. 2 shows a cross section of a battery module 200 similar to battery module 102 from FIG. 1. A first battery 210 and a second battery 212 are shown. A carrier frame 202 includes a first cavity 204 and a second opposing cavity 206. The first battery 210 and the second battery 212 are shown located at least partially within the a first cavity 204 and the second cavity 206. In one example, the batteries 210, 212 are lithium ion batteries, sodium ion batteries, other alkaline ion batteries, or combinations thereof. The format of the batteries 210, 212 may be prismatic, pouch, or cylindrical battery cells, although the invention is not so limited. Lithium ion pouch and prismatic cells are frequently used in electric vehicle battery modules. A central separator 208 is shown located between the pair of opposing cavities 204, 206.

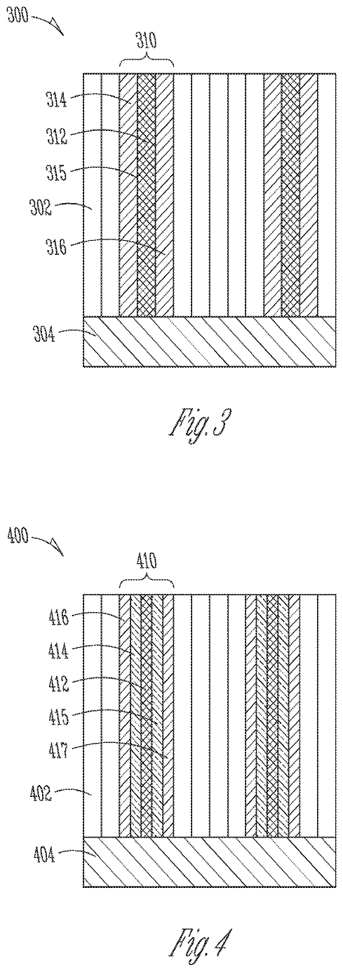

FIG. 3 shows a battery module 300 similar to battery module 102 from FIG. 1. The module 300 includes a stack of lithium ion pouch cells 302. Although pouch cells are used as an example the invention is not so limited. Other battery configurations and chemistries are also within the scope of the invention. A multilayer thermal regulating member 310 is shown separating one or more of the cells 302. The multilayer thermal regulating member 310 includes an thermal insulating layer 312 and a thermal conductive plate 314. The thermal insulating layer and the thermal conductive layer are also referred to as aerogel layer and thermal conductor plate, respectively. In one example, the thermal conductor plate 314 serves as a structural support plate, in addition to thermal conduction. In one example the aerogel layer 312 is continuous aerogel. In one example the aerogel layer 312 includes aerogel particles within a binder. In one aspect the aerogel layer 312 includes aerogel with reinforcement materials. In the example of FIG. 3, a second thermal conductor plate 316 is included, and the aerogel 312 is between two thermal conductor plates. A heat sink 304 is shown in FIG. 3, in thermal communication with an edge of the thermal conductor plates 314, 316.

In one example, a material such as metal forms the thermal conductor plate 314. In operation, the metal, or other heat conducting material transmits heat away from the cells 302 and into one or more heat sinks 304 located adjacent to the stack of lithium ion pouch cells 302 and the thermal conductor plate 314. The inclusion of the aerogel layer 312 provides heat insulation in the event of a thermal runaway in one or more of the cells 302. One or more aerogel layer 312 help to isolate any overheated batteries in a stack within a system, such as system 100 from FIG. 1. At the same time, thermal conduction from the thermal conductor plate 314 helps to cool the cells 302. In this way, the thermal regulating member 310 provides both cooling to improve battery performance, and thermal insulation from the aerogel layer 312.

In one example, the aerogel layer 312 forms a direct interface with the thermal conductor plate 314, without any intervening adhesive layer. In operation, adhesive layers typically have a lower thermal decomposition temperature compared to the aerogel layer 312. By eliminating the adhesive layer, the battery module 300 will exhibit a higher temperature window of stable operation, because no intervening layers are present to prematurely decompose.

In one example, the aerogel layer 312 is painted or sprayed directly onto the thermal conductor plate 314. This manufacturing process facilitates the omission of an adhesive or other binder layer. In one example, a slurry is applied on the thermal conductor plate 314 in a form of a solution and then gelled on the thermal conductor plate 314. In one example, a gelled sol may be applied on the thermal conductor plate 314.

In one example, the aerogel layer 312 includes a density gradient at an interface 315 between the thermal conductor plate 314 and the aerogel layer 312. In one example, as a result of direct painting or spraying of the aerogel layer 312, a region adjacent to the interface 315 will have a higher density than a location within the aerogel layer 312 that is farther from the interface 315.

In one example, the thermal conductor plate 314 includes a porous or open surface structure that provides a diffusion layer at the interface 315. Examples of such thermal conductor plates include, but are not limited to, metal mesh, metal foam, a net, metal wool, metal batting, or other open structure. In these examples, a density gradient at the interface 315 will at least partially result from a portion of the painted or sprayed aerogel precursor diffusing into the pores, fibers, structure, etc. of the thermal conductor plate 314.

FIG. 4 shows a battery module 400 similar to battery module 102 from FIG. 1. The module 400 includes a stack of lithium ion pouch cells 402. Other battery configurations and chemistries are also within the scope of the invention. A multilayer thermal regulating member 410 is shown separating one or more of the cells 402. The multilayer thermal regulating member 410 includes an aerogel layer 412 and a thermal conductor plate 416. In one example, the thermal conductor plate 416 serves as a structural support plate, in addition to thermal conduction. In the example of FIG. 4, a second thermal conductor plate 417 is included, and the aerogel 412 is between two thermal conductor plates. A heat sink 404 is shown in FIG. 4, in thermal communication with an edge of the thermal conductor plates 416, 417.

FIG. 4 shows a first resilient material layer 414 and a second resilient material layer 415. Although two resilient material layers 414, 415 are shown, the invention is not so limited. A single resilient layer, or more than two resilient layers are also possible. In operation, inclusion of a resilient material layer 414, 415 provides an ability to ebb and flow an amount of space in response to thermal expansion and contraction, or in response to swelling and shrinking of battery electrodes within the cells 402. Additionally, in the event of a fire, or a thermal runaway event, the resilient material layers 414, 415 may burn out, and leave behind a gap that provides physical separation between layers in the multilayer thermal regulating member 410. A physical separation may further aid in reducing heat spreading to adjacent cells 402 on other sides of the thermal regulating member 410.

In selected examples as described above, the thermal conductor plates as described can be replaced with non-thermal conductor materials that provide structural support, but do not operate to conduct heat to any heat sinks. A structural support plate can be useful in forming a thermal regulating member, because it provides a base for application of an aerogel precursor to be painted or sprayed on. Examples of structural support plates that are not thermal conductors include, but are not limited to, mica plate, mica paper, other forms of mica, felt, foamed polymers, solid polymers, composite materials, etc. In selected examples, non-thermal conducting structural support plates may include pores, fibers, or other surface structure that results in a diffusion layer at an application interface. As discussed above, in these examples, a density gradient at the interface will at least partially result from a portion of the painted or sprayed aerogel precursor diffusing into the pores, fibers, structure, etc. of the structural support plate.

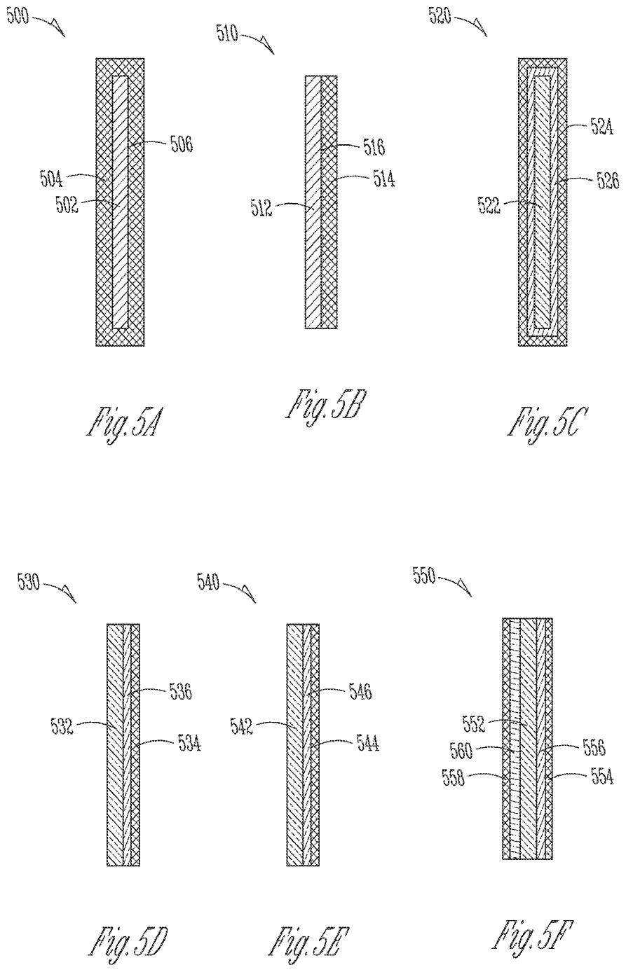

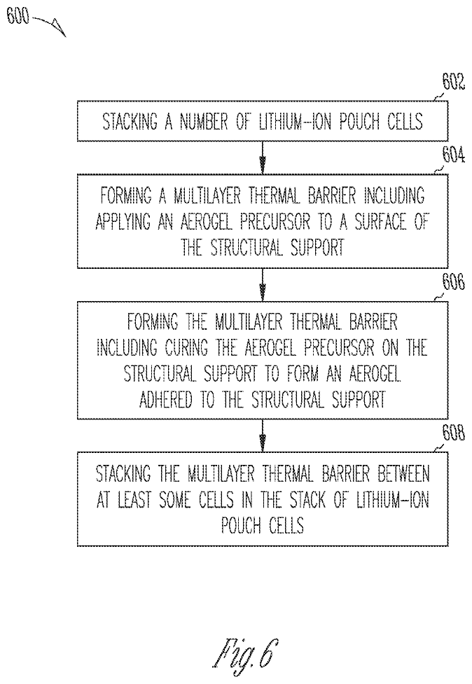

FIGS. 5A-5F show selected examples of structural support plates. In examples where the structural support plate is formed from a thermal conductor material, the structural support plate is also a thermal conductor plate. Example structural support plates and/or thermal conductor plates shown in FIGS. 5A-5F can be used in any combination with examples of battery modules as described above, for example, in FIGS. 1-3.

FIG. 5A shows a thermal regulating member 500 according to one example. The thermal regulating member 500 includes a structural support plate 502 and an aerogel layer 504 coupled to the structural support plate. As discussed in examples above, an aerogel density gradient is present at an interface 506 between the structural support plate 502 and the aerogel layer 504 as a result of the method of manufacture. In the example shown, the aerogel layer 504 surrounds all sides of the structural support plate 502. Alternatively, the aerogel layer 504 may only surround lateral sides of the structural support plate 502. Exposed top or bottom ends of the structural support plate 502 may be coupled to a heat sink for thermal conduction, in examples where the structural support plate 502 is formed from a conducting material such as metal.

In an alternative aspect, the structural support plate 502 may comprise mica plate, mica paper, or other mica structure, or combinations thereof.

In an alternative aspect, the structural support plate 502 may be a first aerogel with reinforcement, where the aerogel layer 504 may be a second aerogel layer. The second aerogel layer may include the same aerogel as the first aerogel layer, such as a silica aerogel. The second aerogel layer may include a different aerogel from the first aerogel layer. For example, the first aerogel layer may include inorganic aerogel, whereas the second aerogel layer may include organic aerogel. In one aspect, the first aerogel layer is a fiber reinforced aerogel blanket and the second aerogel layer is a aerogel paint, where the second aerogel layer encapsulates the first aerogel layer, therefore preventing dust generated from the first aerogel layer.

FIG. 5B shows a thermal regulating member 510 according to one example. The thermal regulating member 510 includes a structural support plate 512 and an aerogel layer 514 coupled to one side of the structural support plate 512. As discussed in examples above, an aerogel density gradient is present at an interface 516 between the structural support plate 512 and the aerogel layer 514 as a result of the method of manufacture.

FIG. 5C shows a thermal regulating member 520 according to one example. The thermal regulating member 520 includes a structural support plate 522 and an aerogel layer 524 coupled to the structural support plate 522. An aerogel density gradient in the form of a diffusion layer 526 is present at an interface between the structural support plate 522 and the aerogel layer 524 as a result of the method of manufacture. In the example shown, the aerogel layer 524 surrounds all lateral sides of the structural support plate 522. Exposed top or bottom ends of the structural support plate 502 may be coupled to a heat sink for thermal conduction, in examples where the structural support plate 522 is formed from a conducting material such as metal. The structural support plate 522 can be a mesh, foam, fiber, felt, etc, such that the aerogel in binder diffuses into the mesh, foam, fiber or felt after applying. The diffusion forms a gradient at the interface.

FIG. 5D shows a thermal regulating member 530 according to one example. The thermal regulating member 530 includes a structural support plate 532 and an aerogel layer 534 coupled to one side of the structural support plate. An aerogel density gradient in the form of a diffusion layer 536 is present at an interface between the structural support plate 532 and the aerogel layer 534 as a result of the method of manufacture.

FIG. 5E shows a thermal regulating member 540 according to one example. The thermal regulating member 540 includes a structural support plate 542 and an aerogel layer 544 coupled to the structural support plate. An aerogel density gradient in the form of a diffusion layer 546 is present at an interface between the structural support plate 542 and the aerogel layer 544 as a result of the method of manufacture. In the example of FIG. 5E, the aerogel layer 544 is reinforced, for example with fiber reinforcement, fabric reinforcement, etc. In one example, the aerogel layer 544 is reinforced by adding fibers, or other reinforcing phase to an aerogel slurry that includes aerogel particles and a binder as described above. In one example, the aerogel layer 544 is reinforced by adding fibers, or other reinforcing phase to a sol, which forms a monolithic aerogel that includes entrained reinforcing fibers.

FIG. 5F shows a thermal regulating member 550 according to one example. The thermal regulating member 550 includes a structural support plate 552 and a first aerogel layer 554 coupled to a first side of the structural support plate 552. An aerogel density gradient in the form of a diffusion layer 556 is present at an interface between the structural support plate 552 and the first aerogel layer 554 as a result of the method of manufacture. A second aerogel layer 558 is also shown coupled to a second side of the structural support plate 552. Examples of a support plate 552 include, but are not limited to, mesh, foam, fiber, felt, etc. A second aerogel density gradient in the form of a second diffusion layer 560 is present at an interface between the structural support plate 552 and the second aerogel layer 558 as a result of the method of manufacture. In one example, the first aerogel layer 554 and the second aerogel layer 558 are the same material. In one example, the first aerogel layer 554 and the second aerogel layer 558 are different materials. In one aspect, the first aerogel layer 554 may be an inorganic aerogel layer, while the second aerogel layer 558 is an organic aerogel layer In another aspect, the first aerogel layer 554 may be a silica aerogel layer, while the second aerogel layer 558 is an aluminum aerogel layer.

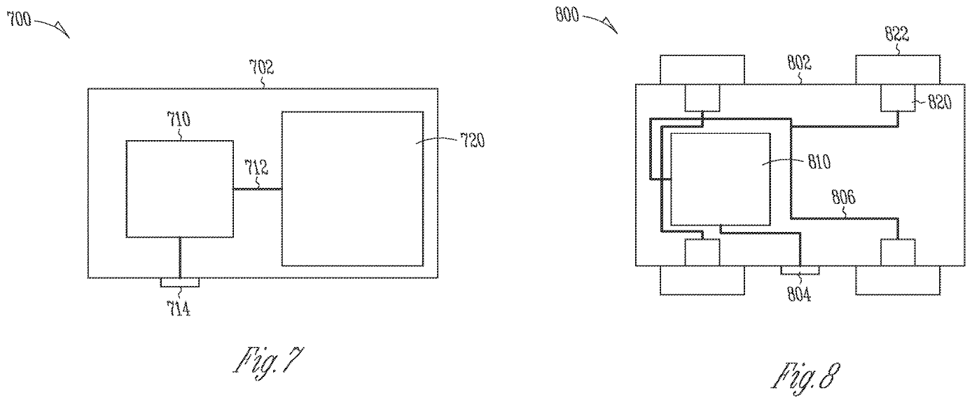

FIG. 6 shows a flow diagram of an example method of manufacture. In operation 602, a number of battery cells are stacked together. In operation 604, a multilayer thermal barrier is formed, including applying an aerogel precursor to a surface of the structural support. In operation 606, a multilayer thermal barrier is formed, including curing the aerogel precursor on the structural support to form an aerogel adhered to the structural support. In operation 608, the multilayer thermal barrier is stacked between at least some cells in the stack of lithium-ion pouch cells.

Battery modules as described above are used in a number of electronic devices. FIG. 7 illustrates an example electronic device 700 that includes a battery module 710. The battery module 710 is coupled to functional electronics 720 by circuitry 712. In the example shown, the battery module 710 and circuitry 712 are contained in a housing 702. A charge port 714 is shown coupled to the battery module 710 to facilitate recharging of the battery module 710 when needed.

In one example, the functional electronics 720 include devices such as semiconductor devices with transistors and storage circuits. Examples include, but are not limited to, telephones, computers, display screens, navigation systems, etc.

FIG. 8 illustrates another electronic system that utilizes battery modules that include multilayer thermal barriers as described above. An electric vehicle 800 is illustrated in FIG. 8. The electric vehicle 800 includes a chassis 802 and wheels 822. In the example shown, each wheel 822 is coupled to a drive motor 820. A battery module 810 is shown coupled to the drive motors 820 by circuitry 806. A charge port 804 is shown coupled to the battery module 810 to facilitate recharging of the battery module 810 when needed.

Examples of electric vehicle 800 include, but are not limited to, consumer vehicles such as cars, trucks, etc. Commercial vehicles such as tractors and semi-trucks are also within the scope of the invention. Although a four wheeled vehicle is shown, the invention is not so limited. For example, two wheeled vehicles such as motorcycles and scooters are also within the scope of the invention.

To better illustrate the method and apparatuses disclosed herein, a non-limiting list of aspects is provided here:

Aspect 1. A thermal regulating member for a battery module, comprising: a structural support plate; and an aerogel layer coupled to the structural support plate; and an acrogel density gradient at an interface between the structural support plate and the aerogel layer.

Aspect 2. The thermal regulating member of aspect 1, wherein the aerogel density gradient includes a diffusion layer.

Aspect 3. The thermal regulating member of aspect 1, further including a resilient layer.

Aspect 4. The thermal regulating member of aspect 1, wherein the aerogel layer includes aerogel particles within a binder.

Aspect 5. The thermal regulating member of aspect 1, wherein the aerogel layer surrounds all lateral sides of the structural support plate.

Aspect 6. The thermal regulating member of aspect 1, wherein the aerogel layer is between two structural support plates.

Aspect 7. The thermal regulating member of aspect 1, wherein the structural support plate includes a metal material.

Aspect 8. The thermal regulating member of aspect 1, wherein the structural support plate includes a resilient material.

Aspect 9. The thermal regulating member of aspect 1, wherein the structural support plate includes a metal mesh.

Aspect 10. The thermal regulating member of aspect 1, wherein the structural support plate includes a foamed material.

Aspect 11. The thermal regulating member of aspect 1, wherein the structural support plate includes a felt material.

Aspect 12. The thermal regulating member of aspect 1, wherein the structural support plate includes a polyurethane material.

Aspect 13. The thermal regulating member of aspect 1, wherein the structural support plate includes mica.

Aspect 14. The thermal regulating member of aspect 1, wherein the structural support plate includes an aerogel with reinforcement.

Aspect 15. A battery module, comprising: a stack of lithium-ion pouch cells; a multilayer thermal regulating member located between cells in the stack of lithium-ion pouch cells, the multilayer thermal regulating member including; a thermal conductor plate; and an aerogel layer adhered to, and forming a direct interface with the thermal conductor plate.

Aspect 16. The battery module of aspect 15, wherein the aerogel layer surrounds all lateral sides of the thermal conductor plate.

Aspect 17. The battery module of aspect 15, further including a heat sink located on a side of the stack of lithium-ion pouch cells, and thermally coupled to the thermal conductor plate on an end surface.

Aspect 18. The battery module of aspect 15, further including an aerogel density gradient at the direct interface.

Aspect 19. The battery module of aspect 15, wherein the aerogel layer includes aerogel particles within a binder.

Aspect 20. A method of forming a battery module, comprising: stacking a number of lithium-ion pouch cells; forming a multilayer thermal barrier including; applying an aerogel precursor to a surface of a structural support; curing the aerogel precursor on the structural support to form an aerogel adhered to the structural support; and stacking the multilayer thermal barrier between at least some cells in the number of lithium-ion pouch cells.

Aspect 21. The method of aspect 20, wherein applying includes painting the aerogel precursor.

Aspect 22. The method of aspect 20, wherein applying includes spraying the aerogel precursor.

Aspect 23. The method of aspect 20, wherein curing includes removing a solvent from a gelled aerogel sol precursor.

Aspect 24. The method of aspect 20, wherein curing includes drying an aerogel slurry.

The above description is intended to be illustrative, and not restrictive. For example, the above-described examples (or one or more aspects thereof) may be used in combination with each other. Other aspects can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Description of Aspects, various features may be grouped together to streamline the disclosure. This should not be interpreted as intending that an unclaimed disclosed feature is essential to any claim. Rather, inventive subject matter may lie in less than all features of a particular disclosed aspect. Thus, the following claims are hereby incorporated into the Description of Aspects, with each claim standing on its own as a separate aspect, and it is contemplated that such aspects can be combined with each other in various combinations or permutations. The scope of the invention should be determined with reference to the appended claims, along with the full scope of equivalents to which such claims are entitled.

Although an overview of the inventive subject matter has been described with reference to specific aspects, various modifications and changes may be made to these aspects without departing from the broader scope of aspects of the present disclosure. Such aspects of the inventive subject matter may be referred to herein, individually or collectively, by the term “invention” merely for convenience and without intending to voluntarily limit the scope of this application to any single disclosure or inventive concept if more than one is, in fact, disclosed.

The aspects illustrated herein are described in sufficient detail to enable those skilled in the art to practice the teachings disclosed. Other aspects may be used and derived therefrom, such that structural and logical substitutions and changes may be made without departing from the scope of this disclosure. The Detailed Description, therefore, is not to be taken in a limiting sense, and the scope of various aspects is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various aspects of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of aspects of the present disclosure as represented by the appended claims. The specification and drawings are, accordingly, to be regarded in an illustrative rather than a restrictive sense.

The foregoing description, for the purpose of explanation, has been described with reference to specific aspects. However, the illustrative discussions above are not intended to be exhaustive or to limit the possible aspects to the precise forms disclosed. Many modifications and variations are possible in view of the above teachings. The aspects were chosen and described in order to best explain the principles involved and their practical applications, to thereby enable others skilled in the art to best utilize the various aspects with various modifications as are suited to the particular use contemplated.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present aspects. The first contact and the second contact are both contacts, but they are not the same contact.

The terminology used in the description of the aspects herein is for the purpose of describing particular aspects only and is not intended to be limiting. As used in the description of the aspects and the appended examples, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting.” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

1. A thermal regulating member for a battery module, comprising:
a structural support plate; and
an aerogel layer coupled to the structural support plate wherein the aerogel layer includes an aerogel density gradient at an interface between the structural support plate and the aerogel layer.

2. The thermal regulating member of claim 1, wherein the aerogel density gradient disposed within a diffusion layer portion of the structural support plate.

3. The thermal regulating member of claim 1, further including a resilient layer.

4. The thermal regulating member of claim 1, wherein the aerogel layer includes aerogel particles within a binder.

5. The thermal regulating member of claim 1, wherein the aerogel layer surrounds all lateral sides of the structural support plate.

6. The thermal regulating member of claim 1, wherein the aerogel layer is between two structural support plates.

7. The thermal regulating member of claim 1, wherein the structural support plate includes a metal material.

8. The thermal regulating member of claim 1, wherein the structural support plate includes a resilient material.

9. The thermal regulating member of claim 1, wherein the structural support plate includes a metal mesh.

10. The thermal regulating member of claim 1, wherein the structural support plate includes a foamed material.

11. The thermal regulating member of claim 1, wherein the structural support plate includes a felt material.

12. The thermal regulating member of claim 1, wherein the structural support plate includes a polyurethane material.

13. The thermal regulating member of claim 1, wherein the structural support plate includes mica.

14. The thermal regulating member of claim 1, wherein the structural support plate includes an aerogel with reinforcement.

15. A battery module, comprising:
a stack of lithium-ion pouch cells; and
a multilayer thermal regulating member located between cells in the stack of lithium-ion pouch cells, the multilayer thermal regulating member including:
a thermal conductor plate; and
an aerogel layer adhered to, and forming a direct interface with the thermal conductor plate.

16. The battery module of claim 15, wherein the aerogel layer surrounds all lateral sides of the thermal conductor plate.

17. The battery module of claim 15, further including a heat sink located on a side of the stack of lithium-ion pouch cells, and thermally coupled to the thermal conductor plate on an end surface.

18. The battery module of claim 15, further including an aerogel density gradient at the direct interface.

19. The battery module of claim 15, wherein the aerogel layer includes aerogel particles within a binder.

20. A method of forming a battery module, comprising:
stacking a number of lithium-ion pouch cells; and
forming a multilayer thermal barrier including:
applying an aerogel precursor to a surface of a structural support;
curing the aerogel precursor on the structural support to form an aerogel adhered to the structural support; and
stacking the multilayer thermal barrier between at least some cells in the number of lithium-ion pouch cells.

21-24. (canceled)
